(19) United States
(12) Patent Application Publication
(10) Pub. No.: US 2016/0092481 A1
(43) Pub. Date: Mar. 31, 2016

(54) INFORMATION INTEGRATION AND ASSESSMENT

(71) Applicant: AirWatch LLC, Atlanta, GA (US)

(72) Inventors: John Marshall, Atlanta, GA (US); Blake Sorensen, Atlanta, GA (US); Erich Stuntebeck, Marietta, GA (US)

(21) Appl. No.: 14/501,835

(22) Filed: Sep. 30, 2014

(51) Int. Cl. G06F 17/30

(52) U.S. Cl. CPC G06F 17/30312; G06F 17/3053

(57) ABSTRACT

Aspects of information integration and assessment are described. In one embodiment, one or more individuals are identified for information research. The identification may be made with reference to an attendee list, contact list, facial recognition, or user input among other ways. At least one source is identified to survey for information related to the individuals, and the source is surveyed for the information. In various embodiments, the source may comprise one or more social media or enterprise networks, services, or indexed search results, for example. The information is assembled into one or more integrated records, and various reports may be generated using the records. The reports and records may be ranked, displayed, compared, annotated, indexed and stored based on a surrounding context metric, for example. With reference to the reports and records, a user may be able to easily assemble and identify relevant information for reference in various contexts.

### BACKGROUND

In various forms, business and personal information may be spread across different computer systems. For example, individuals may maintain several business and personal computer accounts related to business or personal communications, scheduling, sharing, development, networking, etc. Further, various enterprise computer systems may maintain information specific to employees or individuals of a company or organization. Generally, depending upon which type of information an individual needs to access, the individual will access a particular computer system that stores or hosts the information. Similarly, when searching for information on another individual, it may be necessary to access one or more different computer systems to gather the information.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a networked computing environment for information integration and assessment according to various embodiments described herein.

FIG. 2 illustrates an example schedule display page according to various embodiments described herein.

FIG. 3 illustrates an example report display page according to various embodiments described herein.

FIG. 4 illustrates an example search and parameter display page according to various embodiments described herein.

FIG. 5 illustrates an example information integration and assessment process performed by the computing environment of FIG. 1 according to various embodiments described herein.

FIG. 6 illustrates an example schematic block diagram of the computing environment employed in the networked computing environment of FIG. 1 according to various embodiments of the present disclosure.

### DETAILED DESCRIPTION

With the adoption of new types of client computing devices and cross-computing-platform solutions, users may expect additional assistance with the assembly, organization, and presentation of information, including information related to individuals, over time. In the context of social and business meetings, for example, a user may find it helpful to have an integrated report of information related to one or more individuals that are attending a social or business meeting. As described above, because business and personal information may be spread across different computer systems, it may be difficult and time consuming to assemble and present it in a concise, meaningful way. In many situations, the surrounding context of a meeting or event may dictate the manner which a user desires to have information presented. In other words, for information related to a plurality of individuals, the user may desire a different presentation of the information in the context of a sales meeting as compared to a social function based on the user's purpose for attending the meeting or function, for example.

In the context outlined above, this document describes aspects of information integration and assessment. In one embodiment, an information integration service identifies one or more individuals for information research. The identification may be made with reference to an attendee list, contact list, facial recognition, or user input among other ways. The information integration service also identifies at least one source to survey for information related to the individuals, and surveys the source for the information. In various embodiments, the source may comprise one or more social media or enterprise networks, services, data on a client device, or indexed search results, for example. The information integration service assembles the information into one or more integrated records and generated various reports using the records. The information integration service may further rank, compare, annotate, index, and store the reports based on a surrounding context ranking metric, for example. With reference to the reports and records, a user may be able to easily assemble and identify relevant information for reference in various contexts.

The following paragraphs provide a general description of a representative system and its components followed by a discussion of the operation of the same.

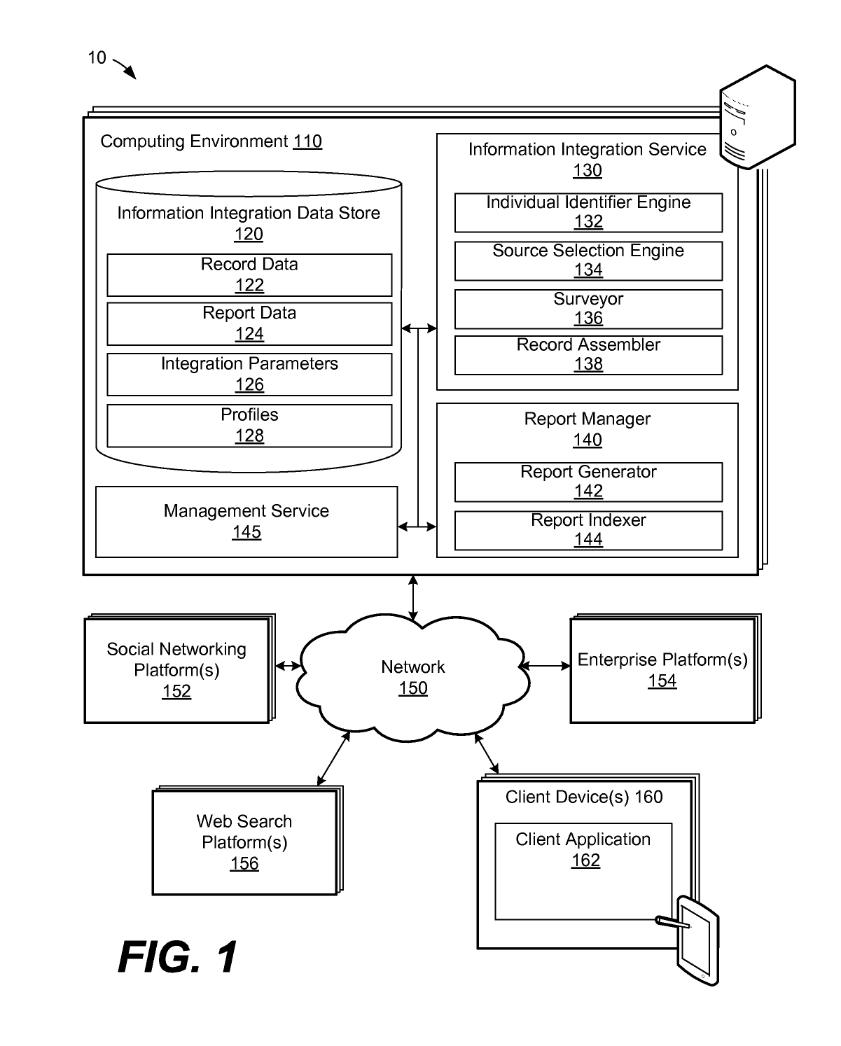

FIG. 1 illustrates a networked environment 10 for information integration and assessment according to various embodiments of the present disclosure. The networked environment 10 includes a computing environment 110, a network 150, a social networking platform 152, an enterprise platform 154, a web search platform 156, and a client device 160.

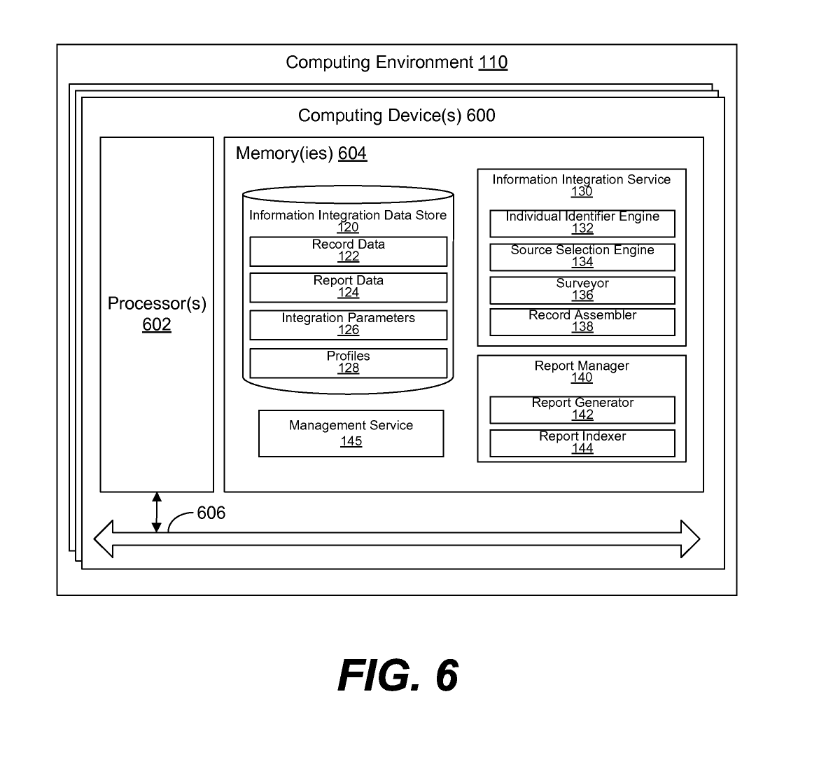

The computing environment 110 may be embodied as a computer, computing device, or computing system. In certain embodiments, the computing environment 110 may include one or more computing devices arranged, for example, in one or more server or computer banks. The computing device or devices may be located at a single installation site or distributed among different geographical locations. As further described below in connection with FIG. 6, the computing environment 110 may include a plurality of computing devices that together embody a hosted computing resource, a grid computing resource, and/or other distributed computing arrangement. In some cases, the computing environment 110 may be embodied as an elastic computing resource where an allotted capacity of processing, network, storage, or other computing-related resources varies over time. The computing environment 110 may also include or correspond to one or more virtualized server instances that are created in order to execute the functionality described herein.

The computing environment 110 may also be embodied, in part, as various functional (e.g., computer-readable instruction) and/or logic (e.g., device, circuit, or processing circuit) elements that may be executed by the computing environment 110 to direct the computing environment 110 to perform aspects of the embodiments described herein. As illustrated in FIG. 1, the computing environment 110 includes an information integration data store 120, an information integration service 130, a report manager 140, and a management service 145, each of which is further described below.

Generally, the computing environment 110 is configured to identify individuals for information research, identify sources to survey for information related to the individuals, survey the sources for the information, assemble the information into records, generate various reports on the individuals, index the reports for reference, and encode the reports for rendering and display. In this context, the computing environment 110 may be configured to automatically identify the individuals for information research with reference to a list of attendees for an upcoming meeting, a contact list, or a picture of one or more individuals. Alternatively, the computing environment 110 may specifically receive an identifier (e.g., name, employee number, etc.) of one or more individuals for information research from a user.

The computing environment 110 may also be configured to survey, assemble, and report on information based on one or more parameters, as further described below, and rank reports and records on individuals based on a surrounding context ranking metric. For example, starting with records for a number of individuals, the computing environment 110 may be configured to rank the individuals based on the potential for or affinity to certain business or employment sectors, geographic locations, coinciding interests, mutual friends or business partners, etc.

In various circumstances, the computing environment 110 may be relied upon to identify individuals, survey sources for information, assemble the information, and generate reports in advance of or during certain events. As one example, the computing environment 110 may be relied upon to generate reports before a meeting, based on the attendee list for the meeting. Alternatively, the computing environment 110 may be relied upon to generate reports during the meeting or at any time, including when in public and in emergency situations. Thus, the embodiments described herein may be relied upon in various circumstances when organized information related to one or more individuals is needed quickly.

The network 150 may include the Internet, intranets, extranets, wide area networks (WANs), local area networks (LANs), wired networks, wireless networks, cable networks, satellite networks, other suitable networks, or any combinations thereof. The computing environment 110 may communicate with other network elements using various protocols such as hypertext transfer protocol (HTTP), simple object access protocol (SOAP), representational state transfer (REST), real-time transport protocol (RTP), real time streaming protocol (RTSP), real time messaging protocol (RTMP), user datagram protocol (UDP), internet protocol (IP), transmission control protocol (TCP), and/or other protocols for communicating data over the network 150, without limitation. The network 150 may include connections to any number and type of network hosts, such as website servers, file servers, cloud computing resources, databases, data stores, or any other network or computing architectures.

The social networking platform 152 may be embodied as a computer, computing device, or computing system that operates as one or more social networking systems, such as the Facebook®, Twitter®, Linked-In®, Flickr®, Instagram®, VMware® SocialCast, etc. social networking systems, without limitation. In certain embodiments, the social networking platform 152 may be similar in composition to the computing environment 110, including one or more computing devices arranged, for example, in one or more server or computer banks. In various embodiments, the computing environment 110 may access the social networking platform 152 by way of the network 150 using a public or private application programming interface (API) of the social networking platform 152, for example, or using any other suitable approach, including but not limited to crawling or indexing pages or files hosted by the social networking platform 152. The social networking platform 152 may be relied upon by the computing environment 110 as a source for information related to individuals, as further described below.

The enterprise platform 154 may be embodied as a computer, computing device, or computing system that operates as one or more enterprise platforms to manage data for a company or organization. For example, the enterprise platform 154 may manage an e-mail service, document management service, customer management service, content management service, employee management service, payroll service, etc. for the company or organization. In this context, the enterprise platform 154 may store data related to various individuals, such as employees, customers, vendors, clients, partners, etc. of the company or organization. In certain embodiments, the enterprise platform 154 may be similar in composition to the computing environment 110, including one or more computing devices arranged, for example, in one or more server or computer banks. In various embodiments, the computing environment 110 may access the enterprise platform 154 by way of the network 150, or the enterprise platform 154 may be integrated with the computing environment 110.

The web search platform 156 may be embodied as a computer, computing device, or computing system that operates as one or more Internet indexing or crawling services, such as the Google®, Bing®, Yahoo®, etc. services, without limitation. In certain embodiments, the web search platform 156 may be similar in composition to the computing environment 110, including one or more computing devices arranged, for example, in one or more server or computer banks. In various embodiments, the computing environment 110 may access the web search platform 156 by way of the network 150 using an application programming interface of the web search platform 156, for example, or using any other suitable approach. The web search platform 156 may be relied upon by the computing environment 110 as a source for information related to individuals, as further described below.

Generally, the social networking platform 152, enterprise platform 154, and web search platform 156 are provided by way of example and not limitation of sources which may be surveyed by the computing environment 110 for the purpose of information integration and assessment. The information integration service 130 may rely upon additional sources of information when preparing reports and identifying and/or ranking contacts. For example, by accessing data stored in the client device 160, the information integration service 130 may examine the frequency or duration of calls to or from contacts, the frequency or length of SMS messages to or from contacts, or the frequency, length, or file size of emails to or from contacts. In this sense, the information integration service 130 may leverage data accessible from the client device 160 in addition to data accessible from the social networking platform 152, enterprise platform 154, and web search platform 156. In this way, the data collection processes of the information integration service 130 seek and obtain data from the client device 160 in addition to data from the backbone of the enterprise platform 154 (e.g., role-based access data from active directories, etc.) and other sources.

The client device 160 is representative of one or a plurality of client devices of one or more users. The client device 160 may be embodied as any computing device, processing circuit, or processor based device or system, including those embodied in the form of a desktop computer, a laptop computer, a personal digital assistant, a wearable computing device, a cellular telephone, a set-top box, a music or media player, or a tablet computer, among other example computing devices and systems. Depending upon its primary purpose or function, for example, the client device 160 may include various peripheral devices or components. The peripheral devices may include input or communications devices or modules, such as keyboards, keypads, touch pads, touch screens, microphones, cameras, wireless communications modules (e.g., infra-red, WI-FI, Bluetooth®, etc.), buttons, switches, sensors, etc. The peripheral devices may also include a display, indicator lights, speakers, global navigation satellite system (GNSS) circuitry, accelerometers, gyroscopes, etc., depending upon the primary purpose or function of the client device 160.

As illustrated in FIG. 1, the client device 160 may execute various applications, such as client application 162, which is representative of one application that may be executed on the client device 160. In one embodiment, the client application 162 may be embodied as a browser application that interacts with the computing environment 110 via the network 150. To this end, the client application 162 may be embodied as, for example, a hypertext-based communications application, such as Wget or cURL, or an internet browser, such as the Internet Explorer®, Firefox®, Chrome®, Safari®, and/or Silk® browsers, another type of browser or tool, or a variant thereof, without limitation. Alternatively, the client application 162 may be embodied as a dedicated application or console, such as the Microsoft Outlook® e-mail client, that interacts with the computing environment 110 using a suitable protocol via the network 150. As another alternative, the client application 162 may be embodied as a messenger or dialer client or application, such as Microsoft Lync®, Short Messaging Service (SMS), Multimedia Messaging Service (MMS), etc. Generally, when executed in the client device 160, the client application 162 is configured to interpret and render a webpage, display console, or similar user interface on a display of the client device 160. In the context of rendering reports generated by the report generator 142, as further described below, any of the examples of the client application 162 (or variants thereof) may interpret and render the reports to a display of the client device 160.

According to certain aspects of the embodiments described herein, as part of a service accessible to the client device 160, the computing environment 110 is configured to survey sources of information related to individuals, such as the social networking platform 152, the enterprise platform 154, and the web search platform 156, for example, and assemble the information into records. In turn, the computing environment 110 is further configured to generate reports on the individuals based on the records and encode the reports for rendering and display on the client device 160. In that context, it may be assumed among the examples described herein that a user of the client device 160 manipulates the client application 162, for example, to access the information integration and assessment services provided by the computing environment 110. However, that the information integration and assessment services provided by the computing environment 110 may be performed within the client device 160 in certain embodiments. That is, in some embodiments, elements similar to the information integration service 130, the report manager 140, and the information integration data store 120 may be implemented, at least in part, directly in the client device 160.

Next, a more detailed description of the operation of the computing environment 110 is provided. In the computing environment 110, the information integration service 130 includes one or more logic elements, engines, or services that perform or embody various aspects of the features described herein, including individual identifier engine 132, source selection engine 134, surveyor 136, and record assembler 138. Additionally, the report manager 140 includes one or more logic elements, engines, or services that perform or embody various aspects of the features described herein, including report generator 142 and report indexer 144. Further, the information integration data store 120 includes various types of data including record data 122, report data 124, and integration parameters 126.

The individual identifier engine 132 identifies one or more individuals for information research. As noted above, the individual identifier engine 132 may identify one or more individuals in various ways depending upon the manner in which the computing environment 110 is being relied upon for information integration and assessment. In one embodiment, the individual identifier engine 132 identifies individuals within a certain geographic range of the client device 160. The individual identifier engine 132 may identify such individuals based at least in part on a detected proximity of the client device 160 to a computing device associated with the individuals. This determination may be made based on the proximity between the client device 160 and client devices of other individuals and may be defined by an administrator using the management service 145. In this sense, proximity may be defined and/or limited according to a distance (e.g., 10, 50, 100 meters, etc.) or geographic boundary as described below. Such proximity may be determined using WI-FI or Bluetooth® signal strength, near-field communication (NFC), etc. The determination of proximity may also be made based on wirelessly receiving a device identifier ID#, for example, from a particular device. In some embodiments, the determination of proximity may be defined and/or limited according to one or more geographic boundaries. In this case, the geographic boundaries may be defined by an administrator of the management service 145. The geographic boundaries may be identified by the information integration service 130 and/or the client device 160 using one or more global positioning system (GPS) receivers, cellular, LAN, or virtual-LAN connections, or other geographic boundary reference information.

Additionally or alternatively, the individual identifier engine 132 may identify an individual for information research using a picture of the individual. In this context, the individual identifier engine 132 may be provided with facial or fiducial marker information and rely upon facial recognition or other suitable algorithms for identifying one or more individuals from a picture. In other embodiments, the individual identifier engine 132 may specifically receive an identifier (e.g., name, employee number, etc.) of one or more individuals from a user.

In another embodiment, the individual identifier engine 132 may actively search through the calendar of a user and identify upcoming meetings that the user is scheduled to attend. For any or all of the identified meetings, the individual identifier engine 132 may extract the attendee list and conduct information research on one or more of the individuals scheduled to attend the meeting. In still other embodiments, the individual identifier engine 132 may identify individuals for information research using a combination of the techniques described above. For example, the individual identifier engine 132 may identify individuals within a certain geographic range of the client device 160 and then compare those individuals against an attendee list for a meeting, to compile a final set of individuals for information research. Alternatively, the individual identifier engine 132 may identify individuals in an attendee list for a meeting and then exclude individuals from the attendee list that are not within a certain geographic range of the client device 160.

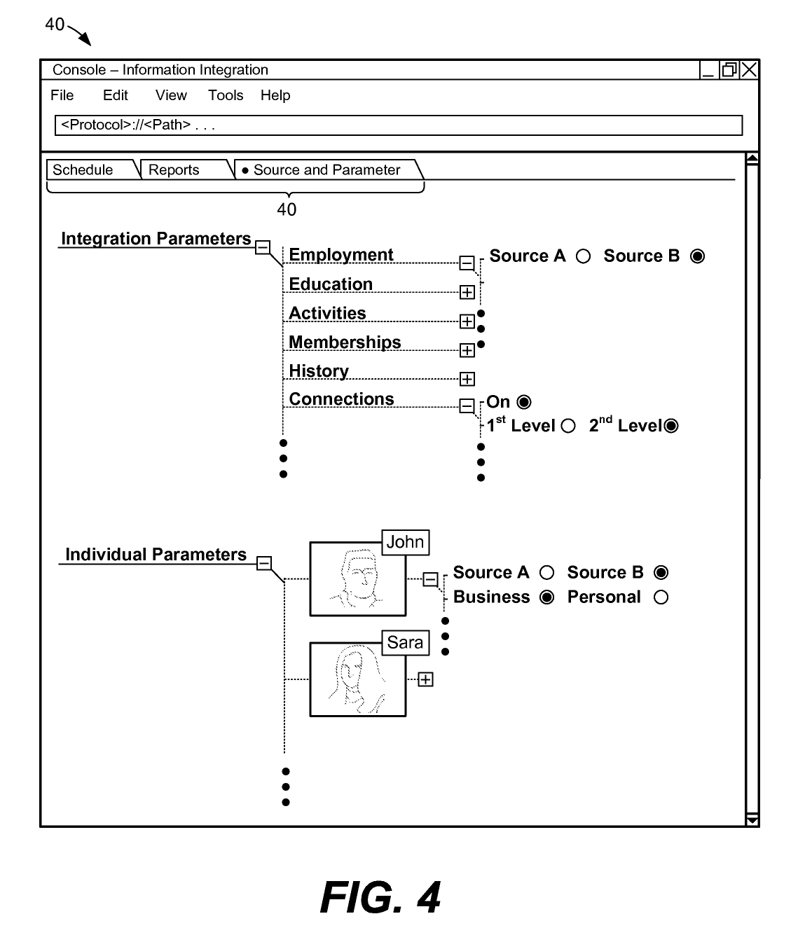

Once the individual identifier engine 132 identifies one or more individuals for information research, the source selection engine 134 is configured to identify at least one source to survey for information related to the individuals. In some embodiments, the source selection engine 134 may identify the sources based on research parameters configured by a user. For example, the computing environment 110 may be configured to limit the number of sources to which it will survey for information on individuals to one or more of the social networking platform 152, the enterprise platform 154, or the web search platform 156. The computing environment 110 may be configured in this fashion based on global or individual research parameters, as discussed in further detail below with reference to FIG. 4.

In one embodiment, depending upon the context in which the computing environment 110 conducts information integration and assessment, the source selection engine 134 may prioritize among various sources for information research. For example, if information research is being conducted on a coworker, the source selection engine 134 may prioritize the enterprise platform 154 over the social networking platform 152 or the web search platform 156, for example, because the enterprise platform 154 may be more likely to contain relevant information related to the individual. Alternatively, if information research is being conducted on individuals in the context of a social gathering, the source selection engine 134 may prioritize the social networking platform 152 over the enterprise platform 154 or the web search platform 156. Generally, the source selection engine 134 may identify and prioritize among various sources for information related to individuals.

The surveyor 136 is configured to survey at least one source identified by the source selection engine 134 for information related to the one or more individuals identified by the individual identifier engine 132. In this context, the surveyor 136 may survey the social networking platform 152, the enterprise platform 154, or the web search platform 156 in any suitable manner. For example, the surveyor 136 may access the social networking platform 152 or the web search platform 156 by way of public or private APIs of the social networking platform 152. As another example, the surveyor 136 may access the enterprise platform 154 using queries to an indexed database, public or private APIs, or by indexing or crawling through data stored by the enterprise platform 154.

The surveyor 136 may search or survey for any type of information related to the one or more individuals identified by the individual identifier engine 132, without limitation. This information may include both personal and professional information, such as the education, employment history, activities, memberships, hobbies, preferences, relationships, photographs, videos, contacts, telephone numbers, e-mail addresses, schedule, etc. of the individuals. Generally, the type of information that may be gathered by the surveyor 136 may depend upon the source of which the information is being gathered. In this context, the information gathered from the social networking platform 152 may be more likely to include personal information, such as the friends and family of the individuals, family photographs, activities, memberships, and hobbies of the individual. In contrast, the information gathered from the enterprise platform 154 may be more likely to include professional information, such as the business title, business schedule, assigned business assets, business contacts, etc.

Once gathered by the surveyor 136, the record assembler 138 is configured to assemble the information for the individuals into one or more integrated records. The integrated records may be organized by the record assembler 138 in any suitable fashion. Generally, the integrated records may be organized to contain all relevant information for a particular individual in a single record. However, as necessary, the record assembler 138 may organize relevant information for a group of individuals into one or a combination of organized records. The records assembled by the record assembler 138 may be stored as the record data 122 for access by the report manager 140 as further described below.

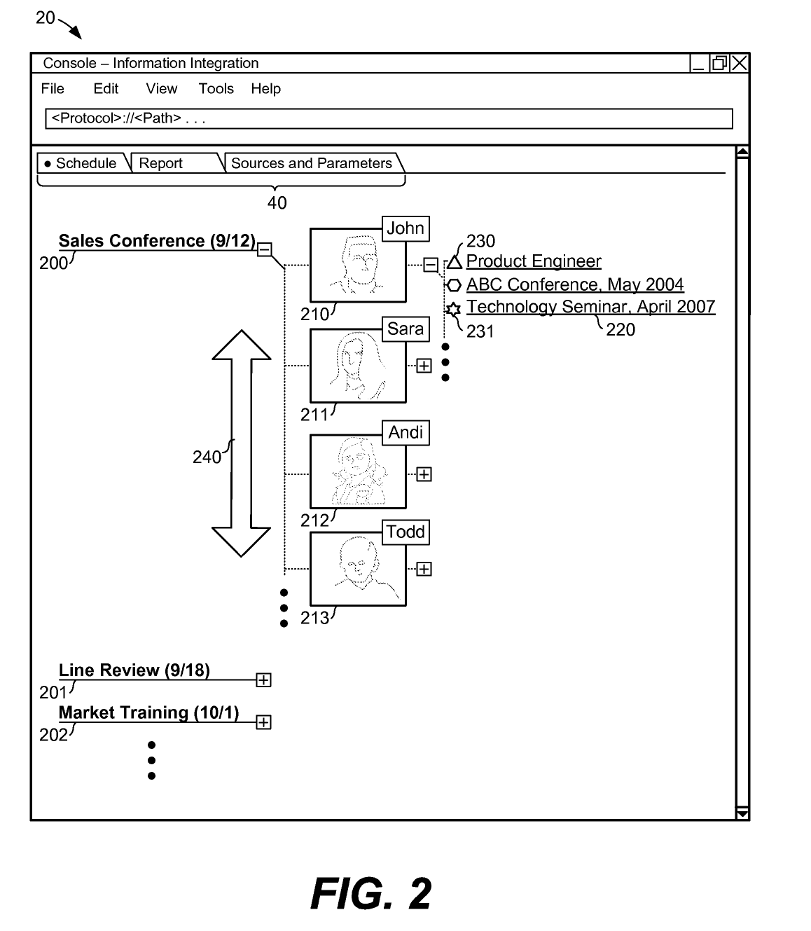

As described above, the information integration service 130 is configured to identify individuals, identify sources to survey for information, survey for the information, and assemble the information into records. Once the information is stored in the information integration data store 120, the information may be additionally organized and presented to a user by the report manager 140. More particularly, the report generator 142 of the report manager 140 is configured to generate and encode a report related to one or more individuals using the data stored in the record data 122 as a basis for the report. In this context, the report generator 142 may encode the report in a format or standard particular to one or more applications executing on the client device 160. As noted above, the client application 162 of the client device 160 may be embodied as a hypertext-based communications application, an internet browser, a dedicated application or console, a messenger or dialer client or application, etc. Thus, among embodiments, the report generator 142 may encode one or more reports according to the formats or standards of the applications executing on the client device 160. In various example cases, the reports may be accessed by the client device 160 using a link to the report, using an event in an application (e.g., an event in Microsoft Outlook), or using a pointer and/or link in a first application when the report is to be rendered by way of a second application. Examples of reports generated by the report generator 142 are described in further detail below with reference to FIGS. 2 and 4.

In certain aspects, the report generator 142 may generate a report based on reporting parameters configured by a user, as described in additional detail below. The report generator 142 may store the generated reports as the report data 124. Once stored as the report data 124, the client device 160 may access the reports, and the client application 162 may render the reports. It is noted, however, that the management service 145 may limit or control access of the client device 160 to the reports, based on various rules as described below.

In certain embodiments, the report generator 142 may be configured to limit the length of a report, direct or limit the report to business or personal contacts or factors, or limit the report to certain sources of information, for example. As further described below, the management service 145 may control access to these reports according to one or more compliance rules defined in the profiles 128.

As further described below with reference to FIGS. 2-4, the reports generated by the report generator 142 may rank or compare various individuals. For example, in the context of a sales meeting, the report generator 142 may rank individuals according to the relative importance of the individuals for the meeting. In this context, the report generator 142 may be configured to compare an integrated record of one individual with another integrated record of another individual and rank the individuals according to certain metrics defined by a reporting parameter, such as connections, affiliations, job title, tenure, years of experience, etc. The report generator 142 may also be configured to evaluate the integrated record of the individual against business sector information and rate the individual according to a reporting parameter. Additionally or alternatively, report generator 142 may also be configured to evaluate the integrated record of the individual for correlation with other individuals based on an affinity parameter, or evaluate the integrated record of the individual to identify one or more personal, professional, and interpersonal connections.

The report indexer 144 may be configured to index one or more reports stored in the report data 124. In this context, the report indexer 144 may be configured to index the reports or data in the reports so that the data may be more easily searched or parsed in the future. Additionally, the report indexer 144 may be configured to search or index through multiple reports to identify common data points, such as common business or personal relationships. Once identified, these common data points may be updated in the record data 122 and/or the report data 124 by the report indexer 144.

The report manager 140 is additionally configured to encode one or more reports or parts of such reports as a display page or interface for rendering on a display device, such as the display device of the client device 160, upon request. In this context, a user of the client device 160 may request that information integration and assessment is performed as well as request a report from the computing environment 110. Based on the processes conducted by the information integration service 130 and the report manager 140, the report manager 140 is configured to provide an encoded page for display, for example, including one or more reports to be displayed on the client device 160.

The management service 145 is configured to facilitate the administration and/or management of the client device 160. For example, the management service 145 may enroll, activate, remove, deactivate, or otherwise manage devices that access the computing environment 110. In this context, the management service 145 may reference the profiles 128 in the information integration data store 120. That is, the management service 145 may be configured to control operating aspects of the client device 160 with reference to the data stored in the profiles 128.

The profiles 128 may contain profile, configuration, or compliance data and/or rules for one or more individuals (e.g., users of client devices) or groups of individuals (e.g., employees of certain business units, etc.), for example. The profiles 128 may store data related to enabling or disabling certain features of the client device 160 for certain users. The credentials of the profiles 128 may include username, password, and/or token data related to the ability of the client device 160 or users of the client device 160 to access the information integration service 130. The compliance rules of the profiles 128 may specify what and how sources, such as the social networking platform 152, the enterprise platform 154, and the web search platform 156, for example, may be used for collection of data (e.g., generally, for specific user groups, for specific users, for users located in certain locations/countries, etc.). The compliance rules of the profiles 128 may specify what and how data may be reported by the report manager 140. For example, certain data may be privileged and (while collected for purposes of indexing) may only be reported to certain users based on the compliance rules of the profiles 128. Similarly, certain data may only be accessible by users in certain geographic locations, users on certain networks, users requesting reports during authorized time windows, etc. The compliance rules of the profiles 128 may be configured by an administrator in a managed enterprise scenario, for example, or by a user in an unmanaged scenario or where the administrator has delegated sufficient privileges to the user.

On the basis of the data stored in the profiles 128, as described above, the management service 145 may be configured to control, direct, or modify one or more features or functions of the computing environment 110. Similarly, on the basis of the data stored in the profiles 128, the management service 145 may control, direct, or modify one or more features, functions, or resources available to the client device 160. In this context, the resources available to the client device 160 may include applications, processing capability, network connectivity, etc. In a more particular example, the management service 145 may permit or deny access of the client device 160 to the information integration service 130 or certain features, data, or reports generated by the information integration service 130. In another example, the management service 145 may be configured to enable or disable the information integration service 130 or configure operating parameters or characteristics of the information integration service 130.

Turning now to examples of display pages or interfaces provided by the computing environment 110, FIG. 2 illustrates an example schedule display page 20. The schedule display page 20 may be generated and encoded by the computing environment 110 and displayed at the client device 160. The schedule display page 20 may be considered an event view report of upcoming events with aggregated data related to certain individuals. In the illustrated embodiment, the schedule display page 20 includes selectable display tabs 40. Using the display tabs 40, schedule, report, or source and parameter views may be selected. In other words, if the schedule tab is selected, a schedule view will be provided on the schedule display page 20. Similarly, if the report tab is selected, a report view will be provided on the schedule display page 20. It should be appreciated, however, that the schedule display page 20 may be organized as any suitable type or arrangement of interface.

In FIG. 2, the schedule tab is selected. As such, the schedule display page 20 tracks a schedule of meetings for a user and provides a menu of scheduled meetings 200, 201, and 202. In other words, based on the calendar of the user, the information integration service 130 has identified that the user is scheduled to attend a sales conference meeting on September 12, a line review meeting on September 18, and market training on October 1, as identified at menus or links 200, 201, and 202, respectively. The calendar of the user may be accessed, for example, through the enterprise platform 154 or the client device 160.

Based on the attendee list for the sales conference 200, the individual identifier engine 132 identified John, Sara, Andi, and Todd, among other individuals, as people scheduled to attend the sales conference meeting on September 12. These individuals may be identified by expanding the sales conference meeting menu 200, as illustrated in FIG. 2. Thus, calendar events are tied to reports on individuals, and the reports may be drilled down on each individual (e.g., John, Sara, Andi, Todd, etc.) associated with the events.

After expanding the sales conference meeting menu 200, the schedule display page 20 provides a menu or link 210, 211, 212, and 213, respectively, for each of John, Sara, Andi, and Todd, as illustrated in FIG. 2. Expanding any of the links 210-213 provides additional information. As shown, expanding the link 210 provides additional information menus or links, one of which is referenced in FIG. 2 as 220. In one embodiment, one or more of the information menus or links may be accessed (e.g., clicked, opened, etc.) to review underlying, associated information. Expanding link 210, John is identified as being a product engineer and as having attended a conference in May 2004, and a seminar in April 2007. The information about John has been assembled from various sources by the computing environment 110. As indicated by the source identifiers 230 and 231, for example, a user may easily identify that the information regarding John's attendance at the seminar in April 2007 was gathered and assembled from a particular source (i.e., “star” source identifier 231) as opposed to the information regarding John's title as a product engineer (i.e., “triangle” source identifier 230).

In other aspects of the embodiments, the links 210-213 may be ranked by the report manager 140. As one example, John may be ranked higher than Sara if John is the organizer of the sales conference meeting on September 12. Alternatively, John may be ranked higher according to one or more reporting parameters that define preferences for the generation of the schedule display page 20. The reporting parameters may define various ranking preferences such as ranking according to connections, affiliations, job title, tenure, years of experience, etc. As another example, John may be ranked higher because of his associations with or affinity to sales or one or more products to be discussed during the meeting. Further, using the rank toggle link 240, a user may specify the manner in which the links 210-213 are ranked, using a menu or dialog box that permits the selection or definition of ranking preferences, for example.

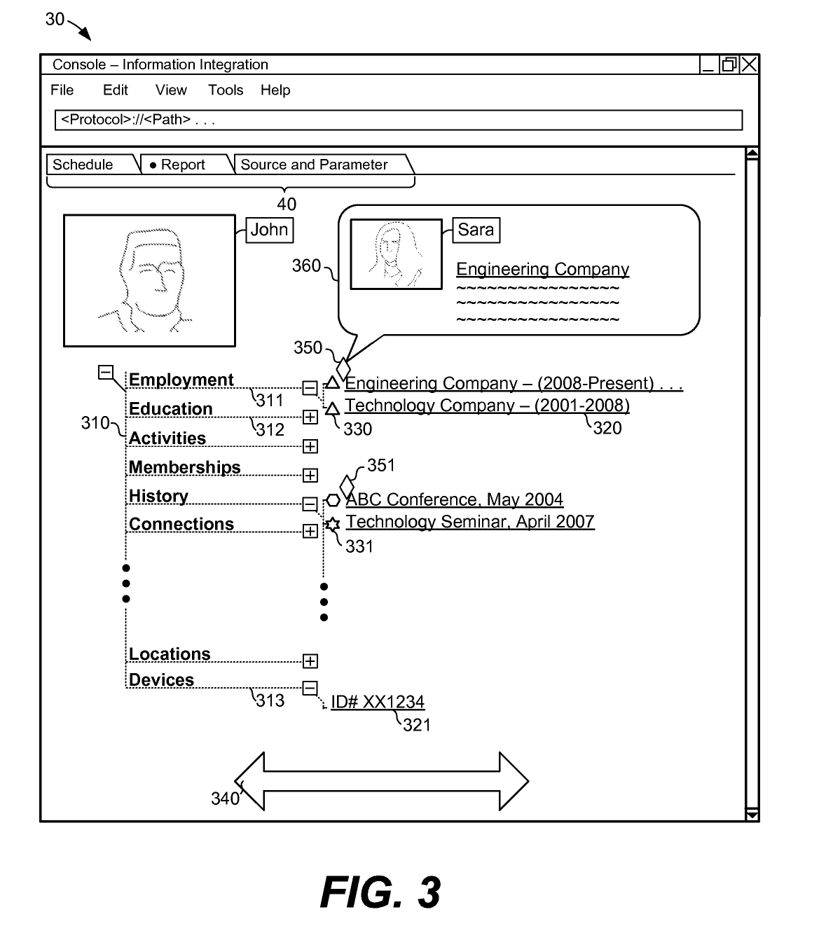

FIG. 3 illustrates an example report display page 30 according to various embodiments described herein. In FIG. 3, the report tab is selected. As such, the report display page 30 provides a more detailed report on a particular individual. As illustrated in FIG. 3, the display page 30 includes a more detailed report on an individual named John. Along the tree 310, category links, such as links 311, 312, and 313, for example, are provided. Expanding any of the category links provides additional information associated with the category. For example, expanding the “Employment” category link 311 provides additional information menus or links for John, one of which is referenced in FIG. 3 as 320. The additional information under the “Employment” category may include information assembled from various sources, including but not limited to the social networking platform 152, the enterprise platform 154, and the web search platform 156. Similarly, any additional information under the other categories along the tree 310 may include information assembled from various sources. Further, using the interface handle 340, a user may browse through reports or search for a particular report using a menu or dialog box, for example.

Referring to the information under the “Employment” category link 311, details on at least part of John's employment history is assembled and organized into the report. For example, the link 320 provides particular information related to John's employment at a technology company from 2001 to 2008. In certain embodiments, the link 320 may be accessed (e.g., clicked, opened, etc.) to review more underlying, associated information. Further, as indicated by the source identifiers 330 and 331 a user may easily identify that the information regarding John's employment at the technology company was gathered and assembled from a particular source (i.e., “triangle” source identifier 330) as opposed to the information regarding John's attendance at the technology seminar in April 2007 (i.e., “star” source identifier 331). In other words, according to the concepts of information integration and assessment described herein, it is clear that information in the report was assembled from various sources and organized together for the report display page 30.

As an additional aspect of the embodiments, when preparing the report display page 30, the computing environment 110 may compare and evaluate similarities and/or differences among integrated records stored in the record data 122 (FIG. 1). More particularly, when preparing the report display page 30, the report generator 142 may be configured to compare an integrated record of one individual with another integrated record of another individual and rank the individuals according to certain metrics defined by a reporting parameter, such as connections, affiliations, etc. Additionally or alternatively, a report generator 142 may also be configured to evaluate the integrated record of the individual for correlation with other individuals based on an affinity parameter, or evaluate the integrated record of the individual to identify one or more personal, professional, and interpersonal connections. The affinity parameter may define a least-distance inter-personal connection, a business relationship or connection, a family relationship or connection, an overlapping education or employment history, etc.

Referring again to FIG. 3, the focus points 350 and 351, among others, may designate one or more affiliations or connections between information in the integrated record of John and in the integrated records of other individuals. In other words, the focus points 350 and 351 highlight one or more personal, professional, or interpersonal connections. In one embodiment, focus points may be accessed (e.g., clicked, opened, etc.) to review certain relevant affiliation or connection information, for example. As illustrated in FIG. 3, the dialog bubble 360 may expand by accessing the focus point 350. In the dialog bubble 360, certain relevant affiliation or connection information between John and Sara is provided. Any relevant information may be provided in the dialog bubble 360 and that, according to the concepts described herein, the report generator 142 may compare integrated records of various individuals to identify and present overlapping, relevant information collected from various sources. In certain aspects, the relevancy of information highlighted using focus points may depend upon the context of a meeting (e.g., a meeting for sales, engineering review, human resources, etc.), the context of a social event (e.g., office party, birthday party, holiday event, etc.), or another surrounding context metric.

According to another aspect of the embodiments, the computing environment 110 may collect certain information which may be used by the client device 160, for example, to identify certain individuals. In FIG. 3, the device identifier ID# for a device is identified at reference numeral 321. The device identifier ID# may consist of a unique identifier associated with a cellular phone or other device issued to or owned by John. This information may have been gathered from the enterprise platform 154, for example. Using the device identifier ID#, the client device 160 may be able to identify that John is present in a room, for example, by wirelessly receiving and identifying a radio beacon from John's cellular phone or other device. Additionally, although not shown, the client device 160 may be provided with facial or fiducial marker information by which the client device 160 may be able to identify John among a room of people using a camera. This may be especially useful if the client device is embodied as a wearable device, such as glasses having a front-facing camera. Similarly, the ability to identify John or another individual may be useful for emergency situations when the identity of a person is forgotten. Once identified, the user of the client device 160 may be quickly presented with a report regarding the individual.

FIG. 4 illustrates an example search and parameter display page 40 according to various embodiments described herein. Generally, the search and parameter display page 40 provides one example of factors that may be defined by a user to determine the manner in which the computing environment 110 performs the processes of information integration and assessment described herein. In the example illustrated, using radio buttons or other interface buttons, prompts, or fields, certain sources may be globally included or excluded from use by the computing environment 110, or included or excluded from use for individuals respectively. Similarly, the evaluation of business or personal connections may be set globally for the computing environment 110 or for individuals respectively. Additionally, one or more forms of analysis, rankings, and/or other features of the reports generated by the computing environment 110 may be turned on or off using the search and parameter display page 40. The information gathered by a user by way of the parameter display page 40 may be stored as the integration parameters 126 (FIG. 1) and relied upon by the report generator 142 when generating a report.

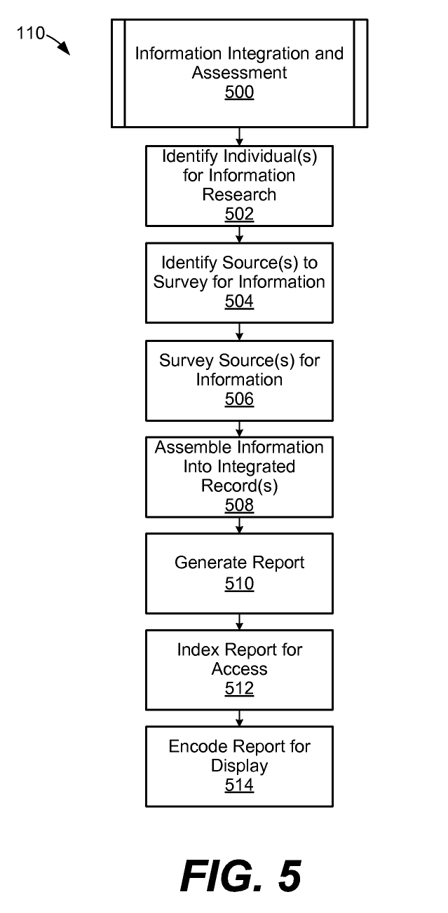

FIG. 5 illustrates an example information integration and assessment process 500 performed by the computing environment 110 of FIG. 1 according to various embodiments described herein. Although the information integration and assessment process 500 is described below as being performed by the computing device 110 in FIG. 1, the information integration and assessment process 500 may be performed by other computing devices and/or systems.

Referring to FIG. 5, at reference numeral 502, the process 500 includes identifying an individual for information research. For example, as described above with reference to FIG. 1, the individual identifier engine 132 may identify one or more individuals for information research at reference numeral 502. The individual identifier engine 132 may identify one or more individuals in various ways depending upon the manner in which the computing environment 110 is being relied upon for information integration and assessment. The individual identifier engine 132 may actively search through the calendar or contact list of a user and identify upcoming social or business meetings. Additionally or alternatively, the individual identifier engine 132 may identify an individual using a picture of the individual by relying upon facial recognition or other suitable algorithms. In other aspects, the individual identifier engine 132 may specifically receive an identifier of one or more individuals from a user at reference numeral 502. The individual identifier engine 132 may also identify such individuals based at least in part on a detected proximity of the client device 160 to a computing device associated with the individuals. Further, the detected proximity may be limited according to one or more geographic boundaries, where the geographic boundaries are defined by an administrator of the management service 145. In other embodiments, the individual identifier engine 132 may identify individuals for information research using a combination of any of the techniques described herein.

In the context of the detection of individuals for information research within a geographic boundary, one example of a geographic boundary is a room or conference area at a trade show. In this case, when a user of the client device 160 walks into the room or conference area, the information integration service 130 and/or the client device 160 may identify one or more individuals for information research based on a detected proximity between the client device 160 and computing devices of the individuals that are within the room or conference area. In this context, it is noted that the room or conference area (or any other similar geographic boundary) may be defined by an administrator using the management service 145. Once individuals attending at the trade show are identified at reference numeral 502, a user of the client device 160 may receive information about the individuals, for example, according to the remainder of the process 500.

At reference numeral 504, the process 500 includes identifying at least one source to survey for information related to the one or more individuals identified at reference numeral 502. For example, as described above with reference to FIG. 1, the source selection engine 134 may identify at least one source to survey for information related to the individuals. In some embodiments, the source selection engine 134 may identify the sources based on research parameters configured by a user. For example, the computing environment 110 may be configured to limit the number of sources to which it will survey for information about one or more of the social networking platform 152, the enterprise platform 154, or the web search platform 156. The computing environment 110 may be configured in this fashion based on global or individual research parameters, as discussed with reference to FIG. 4.

At reference numeral 506, the process 500 includes surveying the at least one source identified at reference numeral 504 for the information related to the individual. For example, as described above with reference to FIG. 1, the surveyor 136 may survey the least one source identified at reference numeral 504 for information related to the one or more individuals identified at reference numeral 502. In this context, the surveyor 136 may survey the social networking platform 152, the enterprise platform 154, or the web search platform 156 (FIG. 1) in any suitable manner. The surveyor 136 may access the social networking platform 152, the enterprise platform 154, or the web search platform 156 by way of public or private APIs, queries to an indexed database, or by indexing or crawling through data, among other ways.

At reference numeral 508, the process 500 includes assembling the information related to the individual into an integrated record for the individual. For example, as described above with reference to FIG. 1, the record assembler 138 may assemble the information for the individuals into one or more integrated records. The integrated records may be organized by the record assembler 138 in any suitable fashion as described herein.

At reference numeral 510, the process 500 includes generating a report on the individual using any integrated records generated at reference numeral 508. The generating, in some embodiments, may be based on at least one reporting parameter as described herein. For example, the report generator 142 may generate a report on one or more individuals using the data stored in the record data 122 as a basis for the report at reference numeral 510. In certain aspects, the report generator 142 may generate a report based on reporting parameters configured by a user. For example, the report generator 142 may be configured to limit the length of a report, direct or limit the report to business or personal contacts or factors, or limit the report to certain sources of information, for example. It is also noted that the reports generated by the report generator 142 may be stored as the report data 124 for access by the report manager 140 at reference numeral 510.

At reference numeral 512, the process 500 includes indexing the report generated at reference numeral 510. For example, as described above with reference to FIG. 1, the report indexer 144 may index one or more reports stored in the report data 124. In this context, the report indexer 144 may be configured to index the reports or data in the reports so that the data may be more easily searched or parsed in the future. Additionally, the report indexer 144 may search or index through multiple reports to identify common data points, such as common business or personal relationships. Once identified, these common data points may be updated in the record data 122 and/or the report data 124 at reference numeral 512. As necessary, any reports generated at reference numeral 510 may be updated based on the indexing at reference numeral 512.

At reference numeral 514, the process 500 includes encoding the report generated at reference numeral 510 for rendering on a display device. For example, as described above with reference to FIG. 1, the report manager 140 may provide an encoded page for display on the client device 160, upon request from the client device 160 or at any predetermined time or according to any predetermined schedule. With reference to the report generated at reference numeral 510, a user may be able to easily identify relevant information for reference in various contexts as described herein.

FIG. 6 illustrates an example schematic block diagram of the computing environment 110 employed in the networked environment 100 of FIG. 1 according to various embodiments of the present disclosure. The computing environment 110 includes one or more computing devices 600. Each computing device 600 includes at least one processing system, for example, having a processor 602 and a memory 604, both of which are electrically and communicatively coupled to a local interface 606. To this end, each computing device 600 may be embodied as, for example, at least one server computer or similar device. The local interface 606 may be embodied as, for example, a data bus with an accompanying address/control bus or other bus structure as can be appreciated.

In various embodiments, the memory 604 stores data and software or executable-code components executable by the processor 602. For example, the memory 604 may store executable-code components associated with the information integration service 130, for execution by the processor 602. The memory 604 may also store data such as that stored in the information integration data store 120, among other data.

The memory 604 may store other executable-code components for execution by the processor 602. For example, an operating system may be stored in the memory 604 for execution by the processor 602. Where any component discussed herein is implemented in the form of software, any one of a number of programming languages may be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, in various embodiments, the memory 604 stores software for execution by the processor 602. In this respect, the terms “executable” or “for execution” refer to software forms that can ultimately be run or executed by the processor 602, whether in source, object, machine, or other form. Examples of executable programs include, for example, a compiled program that can be translated into a machine code format and loaded into a random access portion of the memory 604 and executed by the processor 602, source code that can be expressed in an object code format and loaded into a random access portion of the memory 604 and executed by the processor 602, or source code that can be interpreted by another executable program to generate instructions in a random access portion of the memory 604 and executed by the processor 602, etc. An executable program may be stored in any portion or component of the memory 604 including, for example, a random access memory (RAM), read-only memory (ROM), magnetic or other hard disk drive, solid-state, semiconductor, or similar drive, universal serial bus (USB) flash drive, memory card, optical disc (e.g., compact disc (CD) or digital versatile disc (DVD)), floppy disk, magnetic tape, or other memory component.

In various embodiments, the memory 604 may include both volatile and nonvolatile memory and data storage components. Volatile components are those that do not retain data values upon loss of power. Nonvolatile components are those that retain data upon a loss of power. Thus, the memory 604 may include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM may include, for example, a static random access memory (SRAM), dynamic random access memory (DRAM), or magnetic random access memory (MRAM), and/or other similar memory device. The ROM may include, for example, a programmable read-only memory (PROM), erasable programmable read-only memory (EPROM), electrically erasable programmable read-only memory (EEPROM), or other similar memory device.

Also, the processor 602 may represent multiple processors 602 and/or multiple processor cores, and the memory 604 may represent multiple memories that operate in parallel, respectively, or in combination. Thus, the local interface 606 may be an appropriate network or bus that facilitates communication between any two of the multiple processors 602, between any processor 602 and any of the memories 604, or between any two of the memories 604, etc. The local interface 606 may include additional systems designed to coordinate this communication, including, for example, a load balancer that performs load balancing. The processor 602 may be of electrical or of some other available construction.

As discussed above, the information integration service 130 may be embodied, in part, by software or executable-code components for execution by general purpose hardware. Alternatively the same may be embodied in dedicated hardware or a combination of software, general, specific, and/or dedicated purpose hardware. If embodied in such hardware, each can be implemented as a circuit or state machine, for example, that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart or process diagrams of FIG. 5 are representative of certain processes, functionality, and operations of embodiments discussed herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 602. The machine code may be converted from the source code, etc. Further, each block may represent, or be connected with, a circuit or a number of interconnected circuits to implement a certain logical function or process step.

Although the flowchart or process diagrams of FIG. 5 illustrate a specific order, it is understood that the order may differ from that which is depicted. For example, an order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the information integration service 130 and the report manager 140 that are embodied, at least in part, by software or executable-code components, may be embodied or stored in any tangible or non-transitory computer-readable medium or device for execution by an instruction execution system such as a general purpose processor. In this sense, the logic may be embodied as, for example, software or executable-code components that can be fetched from the computer-readable medium and executed by the instruction execution system. Thus, the instruction execution system may be directed by execution of the instructions to perform certain processes such as those illustrated in FIG. 5. In the context of the present disclosure, a “computer-readable medium” can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium may include a RAM including, for example, an SRAM, DRAM, or MRAM. In addition, the computer-readable medium may include a ROM, a PROM, an EPROM, an EEPROM, or other similar memory device.

Further, any logic or application(s) described herein, including the information integration service 130, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment 110. Additionally, terms such as “application,” “service,” “system,” “engine,” “module,” and so on may be used interchangeably and are not intended to be limiting.

Disjunctive language, such as the phrase “at least one of X, Y, or Z,” unless specifically stated otherwise, is used in general to present that an item, term, etc., may be either X, Y, or Z, or any combination thereof (e.g., X, Y, and/or Z). Thus, such disjunctive language is not generally intended to, and should not imply that, certain embodiments require at least one of X, at least one of Y, or at least one of Z to be each present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying program code executable in at least one computing device, the program code being configured to cause the at least one computing device to at least:
identify an individual for information research, the individual being identified based at least in part on a detected proximity of the at least one computing device to a computing device associated with the individual within an administrator defined geographic boundary;
identify at least one source to survey for information related to the individual;
survey the at least one source for the information related to the individual;
assemble the information related to the individual into an integrated record for the individual;
generate a report on the individual using the integrated record based on at least one reporting parameter;
index the report for access; and
encode the report for rendering on a display device.

2. The non-transitory computer-readable medium of claim 1, wherein the program code is further configured to cause the at least one computing device to:
survey the at least one source for information related to a plurality of individuals; and
rank the plurality of individuals based on a surrounding context ranking metric.

3. The non-transitory computer-readable medium of claim 1, wherein the report comprises an event view of upcoming events and aggregated information related to a plurality of individuals.

4. The non-transitory computer-readable medium of claim 1, wherein the program code is further configured to cause the at least one computing device to assemble the information from at least one of data from a client device, a social media platform, an enterprise network, an e-mail service, or indexed search results.

5. The non-transitory computer-readable medium of claim 1, wherein the program code is further configured to cause the at least one computing device to compare the integrated record of the individual with another integrated record of another individual and rank the individual against the another individual according to the at least one reporting parameter.

6. The non-transitory computer-readable medium of claim 1, wherein the program code is further configured to cause the at least one computing device to evaluate the integrated record of the individual for a correlation with other individuals based on an affinity parameter.

7. The non-transitory computer-readable medium of claim 1, wherein the program code is further configured to cause the at least one computing device to evaluate the integrated record of the individual to identify one or more personal, professional, and interpersonal connections.

8. The non-transitory computer-readable medium of claim 1, wherein the report highlights the one or more personal, professional, or interpersonal connections.

9. A non-transitory computer-readable medium embodying program code executable in at least one computing device, the program code being configured to cause the at least one computing device to at least:
identify a plurality of individuals for information research, the plurality of individuals being identified based at least in part on a detected proximity of the at least one computing device to computing devices associated with the plurality of individuals within an administrator defined geographic boundary;
identify at least one source to survey for information related to the plurality of individuals;
survey the at least one source for the information related to the plurality of individuals;
assemble the information related to the plurality of individuals into integrated records; and
generate a report including a ranking of the plurality of individuals using the integrated records based on a surrounding context ranking metric.

10. The non-transitory computer-readable medium of claim 9, wherein the report comprises an event view of upcoming events and aggregated information related to the plurality of individuals.

11. The non-transitory computer-readable medium of claim 9, wherein the program code is further configured to cause the at least one computing device to identify the plurality of individuals for information research from at least one of a contact list or an attendee list for a scheduled meeting.

12. The non-transitory computer-readable medium of claim 9, wherein the at least one source for information includes at least one of a social media network, an enterprise network, an e-mail service, and indexed search results.

13. The non-transitory computer-readable medium of claim 9, wherein the program code is further configured to cause the at least one computing device to evaluate the integrated records for a correlation among the plurality of individuals.

14. The non-transitory computer-readable medium of claim 9, wherein the program code is further configured to cause the at least one computing device to compare the integrated records and identify one or more personal, professional, or interpersonal connections.

15. The non-transitory computer-readable medium of claim 14, wherein the report highlights the one or more personal, professional, or interpersonal connections.

16. A method, comprising:
identifying, using at least one computing device, an individual for information research;
identifying, using the at least one computing device, identify at least one source to survey for information related to the individual;
assembling, within the at least one computing device, the information related to the individual into an integrated record for the individual;
generating, using the at least one computing device, a report on the individual using the integrated record based on at least one reporting parameter; and
encoding, using the at least one computing device, the report for rendering on a display device.

17. The method of claim 16, further comprising identifying, using the at least one computing device, the individual for information research from at least one of a contact list or an attendee list for a scheduled meeting.

18. The method of claim 16, wherein the at least one source for information includes at least one of a social media network, an enterprise network, an e-mail service, and indexed search results.

19. The method of claim 16, further comprising comparing, using the at least one computing device, the integrated record of the individual with another integrated record of another individual and rank the individual against the another individual according to the at least one reporting parameter.

20. The method of claim 16, further comprising evaluating, using the at least one computing device, the integrated record of the individual for a correlation with other individuals based on an affinity parameter.
